(19) United States
(12) Patent Application Publication
(10) Pub. No.: US 2018/0036952 A1
(43) Pub. Date: Feb. 8, 2018

(54) MULTILAYER EXTRUSION METHOD FOR MATERIAL EXTRUSION ADDITIVE MANUFACTURING

(71) Applicant: SABIC GLOBAL TECHNOLOGIES B.V.,, Bergen op Zoom (NL)

(72) Inventors: Thomas HOCKER, Pittsfield, MA (US); Jeroen Franklin VISJAGER, Newburgh, IN (US); Keith E. COX, Newburgh, IN (US); Malvika BIHARI, Evansville, IN (US)

(73) Assignee: SABIC GLOBAL TECHNOLOGIES B.V.,, Bergen op Zoom (NL)

(21) Appl. No.: 15/537,255

(22) PCT Filed: Dec. 17, 2015
(86) PCT No.: PCT/IB2015/059739

§ 371 Date: Jun. 16, 2017

Related U.S. Application Data
(60) Provisional application No. 62/093,117, filed on Dec. 17, 2014.

(51) Int. Cl. B29C 64/40; B29C 64/118; B29C 64/209; B33Y 10/00

(52) U.S. Cl. CPC B29C 64/40; B33Y 10/00; B29C 64/118; B29C 64/209

(57) ABSTRACT

A method of forming a three dimensional object comprising: moving a first polymer material (30) through a first feed channel (38) of an extrusion die (10) having multiple feed channels; moving a second material (40) through a second feed channel (38) of the extrusion die, wherein the second material comprises a solvent, a release agent, a coating or a second polymer material; forming a multilayered extrudate (20) along an extrusion axis, wherein the multilayered extrudate comprises the first polymer material (30) and the second material (40), and wherein the extrusion axis is parallel to the movement of the multilayered extrudate; depositing a multitude of layers of the multilayered extrudate in a preset pattern on a platform (2); and fusing the multitude of layers to form the three dimensional object. An article of manufacture comprising: a three dimensional object is also disclosed.

### BACKGROUND

Additive Manufacturing (AM) is a new production technology that can transform the way all sorts of things are made. AM can make three-dimensional (3D) solid objects of virtually any shape from a digital model. Generally, this can be achieved by creating a digital model of a desired solid object with computer-aided design (CAD) modeling software and then slicing that virtual blueprint into very small digital cross-sections. These cross-sections can be formed or deposited in a sequential layering process in an AM machine to create the 3D object. AM can have many advantages, including dramatically reducing the time from design to prototyping to commercial product. Running design changes are possible. AM allows designers to imagine shapes that would be impossible to create through older techniques. Multiple parts can be built in a single assembly. No tooling is required. Minimal energy is needed to make these 3D solid objects. It also decreases the amount of waste and raw materials. Parts can be made lighter and more durable than their predecessors. AM can also facilitate production of extremely complex geometrical parts. AM also reduces the parts inventory for a business since parts can be quickly made on-demand and on-site.

Material Extrusion (a type of AM) can be used as a low capital forming process for producing plastic parts, and/or forming process for difficult geometries. Material Extrusion can involve an extrusion-based additive manufacturing system that is used to build a three-dimensional (3D) model from a digital representation of the 3D model in a layer-by-layer manner by selectively dispensing a flowable material through a nozzle or orifice. After the material is extruded, it can be deposited as a sequence of roads on a substrate in an x-y plane. The extruded modeling material can fuse to previously deposited modeling material, and solidify upon cooling. The position of the extrusion head relative to the substrate can then be incremented along a z-axis (perpendicular to the x-y plane), and the process can then be repeated to form a 3D model resembling the digital representation.

Material Extrusion can be used to make final production parts, fixtures, and molds as well as to make prototype models for a wide variety of products. However, the strength of the parts in the build direction can be limited by the bond strength and effective bonding surface area between subsequent layers of the build. These factors can be limited for two reasons. First, each layer can be a separate melt stream. Thus, comingling of the polymer chains of a new layer with those of the antecedent layer can be reduced. Secondly, because the previous layer could have cooled, cohesion between layers can rely on conduction of heat from the new layer and any inherent cohesive properties of the material for bonding to occur. Reduced cohesion between layers can also results in a stratified surface finish.

In the creation of AM parts, portions of the part can be supported by a separate support material. This support material can be separately formed, such as extruded and placed where the model material can benefit from a support structure (e.g., to hold the model material as it cools and solidifies). Once the AM process is complete, support material can be removed from the model to reveal the part. In the past, the removal of support material from the part included mechanical removal of the support. Such removal can scar or otherwise impair the quality of the model surface along the interface between the model and the support material.

Accordingly, a need exists for an enhanced AM process capable of producing parts with improved aesthetic qualities and structural properties, both with and without support materials.

### BRIEF DESCRIPTION

One embodiment of the present invention is drawn to a method of forming a three dimensional object comprising: moving a first polymer material through a first feed channel of an extrusion die having multiple feed channels; moving a second material through a second feed channel of the extrusion die, wherein the second material comprises a solvent, a release agent, a coating or a second polymer material; forming a multilayered extrudate along an extrusion axis, wherein the multilayered extrudate comprises the first polymer material and the second material, and wherein the extrusion axis is parallel to the movement of the multilayered extrudate; depositing a multitude of layers of the multilayered extrudate in a preset pattern on a platform; and fusing the multitude of layers to form the three dimensional object.

Another embodiment of the present invention is drawn to an article of manufacture comprising: a three dimensional object comprising a part made from a first polymer material and a support made from the first polymer material wherein the part and the support are separated by a release agent. The above described and other features are exemplified by the following figures and detailed description.

The above described and other features are exemplified by the following figures and detailed description.

### BRIEF DESCRIPTION OF THE DRAWINGS

Refer now to the figures, which are exemplary embodiments, and wherein the like elements are numbered alike.

FIG. 1 is an illustration of a cross-section of an extrusion die which can form a multilayered extrudate including a first polymer material and a second material.

FIG. 2 is an illustration of a cross-section of an extrusion die which can form a multilayered extrudate including a first polymer material and a second material where the second material can include a second polymer material.

FIG. 3 is an illustration of a cross-section of an extrusion die which can form a multilayered extrudate including a first polymer material, a second material, and a second polymer material.

FIG. 4 is an illustration of a cross-section of a pattern of multilayered extrudate including a first polymer material and a second material deposited by an additive manufacturing device.

FIG. 5 is an illustration of a cross-section of a pattern of multilayered extrudate including a first polymer material and a second material deposited by an additive manufacturing device where the second material can include a solvent and a release agent.

FIG. 6 is an illustration of a cross-section of a pattern of multilayered extrudate deposited by an additive manufacturing device where the multilayered extrudate includes a first polymer material, a solvent, a second polymer material, a second solvent and a release agent.

### DETAILED DESCRIPTION

Disclosed herein are additive manufacturing modeling methods and apparatus capable of producing parts with increased bonding between adjacent model layers, and alternatively, with decreased bonding between model and support material layer. Without being bound by theory, it is believed that the favorable results obtained herein, e.g., high strength three dimensional polymeric components can be achieved by controlling interfacial adhesion (positively for better performance and negatively for better support removal) can overcome some surface tension between layers and can result in cohesion which can enable improved surface quality of parts. Moreover, reduced cohesion between the model and the support material can ease support material removal and improve surface quality of parts along the interface between the model and support material. Accordingly, parts with superior mechanical and aesthetic properties can be manufactured.

The term “material extrusion additive manufacturing technique” as used in the present specification and claims means that the article of manufacture can be made by any additive manufacturing technique that makes a three-dimensional solid object of any shape by laying down material in layers from a thermoplastic material such as a monofilament, powder, or pellet from a digital model by selectively dispensing through a nozzle, orifice, or die. For example, the extruded material can be made by laying down a plastic filament that is unwound from a coil or is deposited from an extrusion head. These monofilament additive manufacturing techniques include fused deposition modeling and fused filament fabrication as well as other material extrusion technologies as defined by ASTM F2792-12a.

The terms “Fused Deposition Modeling” or “Fused Filament Fabrication” involves building a part or article layer-by-layer by heating thermoplastic material to a semi-liquid state and extruding it according to computer-controlled paths. Fused Deposition Modeling utilizes a modeling material and a support material. The modeling material includes the finished piece, and the support material includes scaffolding that can be mechanically removed, washed away or dissolved when the process is complete. The process involves depositing material to complete each layer before the base moves down the Z-axis and the next layer begins.

The material extrusion extruded material can be made from thermoplastic materials. Such materials can include polycarbonate (PC), acrylonitrile butadiene styrene (ABS), acrylic rubber, ethylene-vinyl acetate (EVA), ethylene vinyl alcohol (EVOH), liquid crystal polymer (LCP), methacrylate styrene butadiene (MBS), polyacetal (POM or acetal), polyacrylate and polymethacrylate (also known collectively as acrylics), polyacrylonitrile (PAN), polyamide (PA, also known as nylon), polyamide-imide (PAI), polyaryletherketone (PAEK), polybutadiene (PBD), polybutylene (PB), polyesters such as polybutylene terephthalate (PBT), polycaprolactone (PCL), polyethylene terephthalate (PET), polycyclohexylene dimethylene terephthalate (PCT), and polyhydroxyalkanoates (PHAs), polyketone (PK), polyolefins such as polyethylene (PE) and polypropylene (PP), fluorinated polyolefins such as polytetrafluoroethylene (PTFE) polyetheretherketone (PEEK), polyetherketoneketone (PEKK), polyetherimide (PEI), polyethersulfone (PES), polysulfone, polyimide (PI), polylactic acid (PLA), polymethylpentene (PMP), polyphenylene oxide (PPO), polyphenylene sulfide (PPS), polyphthalamide (PPA), polypropylene (PP), polystyrene (PS), polysulfone (PSU), polyphenylsulfone, polytrimethylene terephthalate (PTT), polyurethane (PU), styrene-acrylonitrile (SAN), or any combination comprising at least one of the foregoing. Polycarbonate blends with ABS, SAN, PBT, PET, PCT, PEI, PTFE, or combinations comprising at least one of the foregoing are of particular note to attain the balance of the desirable properties such as melt flow, impact and chemical resistance. The material extrusion extruded material can also include polycarbonate copolymers such as LEXAN XHT, DMX, HFD, EXL, or FST copolymers or other polycarbonate copolymers. The amount of these other thermoplastic materials can be from 0.1% to 85 wt. %, in other instances, from 1.0% to 50 wt. %, and in yet other instances, from 5% to 30 wt. %, based on the weight of the monofilament.

The term “polycarbonate” as used herein means a polymer or copolymer having repeating structural carbonate units of formula (1)

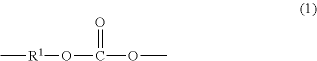

wherein at least 60 percent of the total number of R¹ groups are aromatic, or each R¹ contains at least one C₆₋₃₀ aromatic group. Specifically, each R¹ can be derived from a dihydroxy compound such as an aromatic dihydroxy compound of formula (2) or a bisphenol of formula (3).

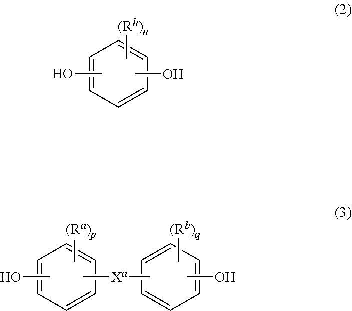

In formula (2), each R^{h} is independently a halogen atom, for example bromine, a C₁₋₁₀ hydrocarbyl group such as a C₁₋₁₀ alkyl, a halogen-substituted C₁₋₁₀ alkyl, a C₆₋₁₀ aryl, or a halogen-substituted C₆₋₁₀ aryl, and n is 0 to 4.

In formula (3), R^{a} and R^{b} are each independently a halogen, C₁₋₁₂ alkoxy, or C₁₋₂ alkyl; and p and q are each independently integers of 0 to 4, such that when p or q is less than 4, the valence of each carbon of the ring is filled by hydrogen. In an embodiment, p and q is each 0, or p and q is each 1, and R^{a} and R^{b} are each a C₁₋₃ alkyl group, specifically methyl, disposed meta to the hydroxy group on each arylene group. X^{a} is a bridging group connecting the two hydroxy-substituted aromatic groups, where the bridging group and the hydroxy substituent of each C₆ arylene group are disposed ortho, meta, or para (specifically para) to each other on the C₆ arylene group, for example, a single bond, —O—, —S—, —S(O)—, —S(O)₂—, —C(O)—, or a C₁₋₁₈ organic group, which can be cyclic or acyclic, aromatic or non-aromatic, and can further include heteroatoms such as halogens, oxygen, nitrogen, sulfur, silicon, or phosphorous. For example, X^{a} can be a substituted or unsubstituted C₃₋₁₈ cycloalkylidene; a C₁₋₂₅ alkylidene of the formula —C(R^{c})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl; or a group of the formula —C(═R^{e})— wherein R^{e} is a divalent C₁₋₁₂ hydrocarbon group.

Some illustrative examples of specific dihydroxy compounds include the following: bisphenol compounds such as 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis (hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole; resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like.

Specific dihydroxy compounds include resorcinol, 2,2-bis(4-hydroxyphenyl) propane (“bisphenol A” or “BPA”, in which each of A¹ and A² is p-phenylene and X^{a} is isopropylidene in formula (3)), 3,3-bis(4-hydroxyphenyl) phthalimidine, 2-phenyl-3,3-bis(4-hydroxyphenyl) phthalimidine (also known as N-phenyl phenolphthalein bisphenol, “PPPBP”, or 3,3-bis(4-hydroxyphenyl)-2-phenylisoindolin-1-one), 1,1-bis(4-hydroxy-3-methylphenyl)cyclohexane (DMBPC), and 1,1-bis(4-hydroxy-3-methylphenyl)-3,3,5-trimethylcyclohexane (isophorone bisphenol).

These aromatic polycarbonates can be manufactured by known processes, for example, by reacting a dihydric phenol with a carbonate precursor, such as phosgene, in accordance with methods set forth in the above-cited literature and in U.S. Pat. No. 4,123,436, or by transesterification processes such as are disclosed in U.S. Pat. No. 3,153,008, as well as other processes known to those skilled in the art.

It is also possible to employ two or more different dihydric phenols in the event a polycarbonate copolymer or interpolymer rather than a homopolymer is desired. Polycarbonate copolymers can include two or more different types of carbonate units, for example units derived from BPA and PPPBP (commercially available under the trade designation XHT from the Innovative Plastics division of SABIC); BPA and DMBPC (commercially available under the trade designation DMX from the Innovative Plastics division of SABIC); or BPA and isophorone bisphenol (commercially available under the trade name APEC from Bayer). The polycarbonate copolymers can further comprise non-carbonate repeating units, for example repeating ester units (polyester-carbonates), such as those comprising bisphenol A carbonate units and isophthalate-terephthalate-bisphenol A ester units, also commonly referred to as poly(carbonate-ester)s (PCE) or poly(phthalate-carbonate)s (PPC), depending on the relative ratio of carbonate units and ester units, also commonly referred to as poly(carbonate-ester)s (PCE) or poly(phthalate-carbonate)s (PPC), depending on the relative ratio of carbonate units and ester units, or those comprising bisphenol A carbonate units and C₆₋₁₂ dicarboxy ester units (commercially available under the trade designation HFD from the Innovative Plastics division of SABIC); repeating siloxane units (polycarbonate-siloxanes), for example those comprising bisphenol A carbonate units, isophthalate-terephthalate-bisphenol A ester units, and siloxane units (e.g., blocks containing 5 to 200 dimethylsiloxane units), such as those commercially available under the trade name FST from the Innovative Plastics division of SABIC; or both ester units and siloxane units (polycarbonate-ester-siloxanes), for example those comprising bisphenol A carbonate units, isophthalate-terephthalate-bisphenol A ester units, and siloxane units (e.g., blocks containing 5 to 200 dimethylsiloxane units), such as those commercially available under the trade name FST from the Innovative Plastics division of SABIC. Branched polycarbonates are also useful, such as are described in U.S. Pat. No. 4,001,184, or highly-branched polycarbonate homopolymers containing cyanophenol endcaps, such as those commercially available under the trade designation CFR from the Innovative Plastics division of SABIC. Also, there can be utilized combinations of linear polycarbonate and a branched polycarbonate. Moreover, combinations of any of the above materials may be used.

In any event, the preferred aromatic polycarbonate is a homopolymer, e.g., a homopolymer derived from 2, 2-bis(4-hydroxyphenyl)propane (bisphenol-A) and a carbonate or carbonate precursor, commercially available under the trade designation LEXAN from SABIC.

The thermoplastic polycarbonates used herein possess a certain combination of chemical and physical properties. They are made from at least 50 mole % bisphenol A, and have a weight-average molecular weight (Mw) of 10,000 to 50,000 grams per mole (g/mol) measured by gel permeation chromatography (GPC) calibrated on polycarbonate standards, and have a glass transition temperature (Tg) from 130 to 180 degrees Centigrade (° C.).

Besides this combination of physical properties, these thermoplastic polycarbonate compositions may also possess certain optional physical properties. These other physical properties include having a tensile strength at yield of greater than 5,000 pounds per square inch (psi), and a flex modulus at 100° C. greater than 1,000 psi (as measured on 3.2 mm bars by dynamic mechanical analysis (DMA) as per ASTM D4065-01).

Other ingredients can also be added to the monofilaments. These include colorants such as solvent violet 36, pigment blue 60, pigment blue 15:1, pigment blue 15.4, carbon black, titanium dioxide or any combination comprising at least one of the foregoing.

A more complete understanding of the components, processes, and apparatuses disclosed herein can be obtained by reference to the accompanying drawings. These figures (also referred to herein as “FIG.”) are merely schematic representations based on convenience and the ease of demonstrating the present disclosure, and are, therefore, not intended to indicate relative size and dimensions of the devices or components thereof and/or to define or limit the scope of the exemplary embodiments. Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

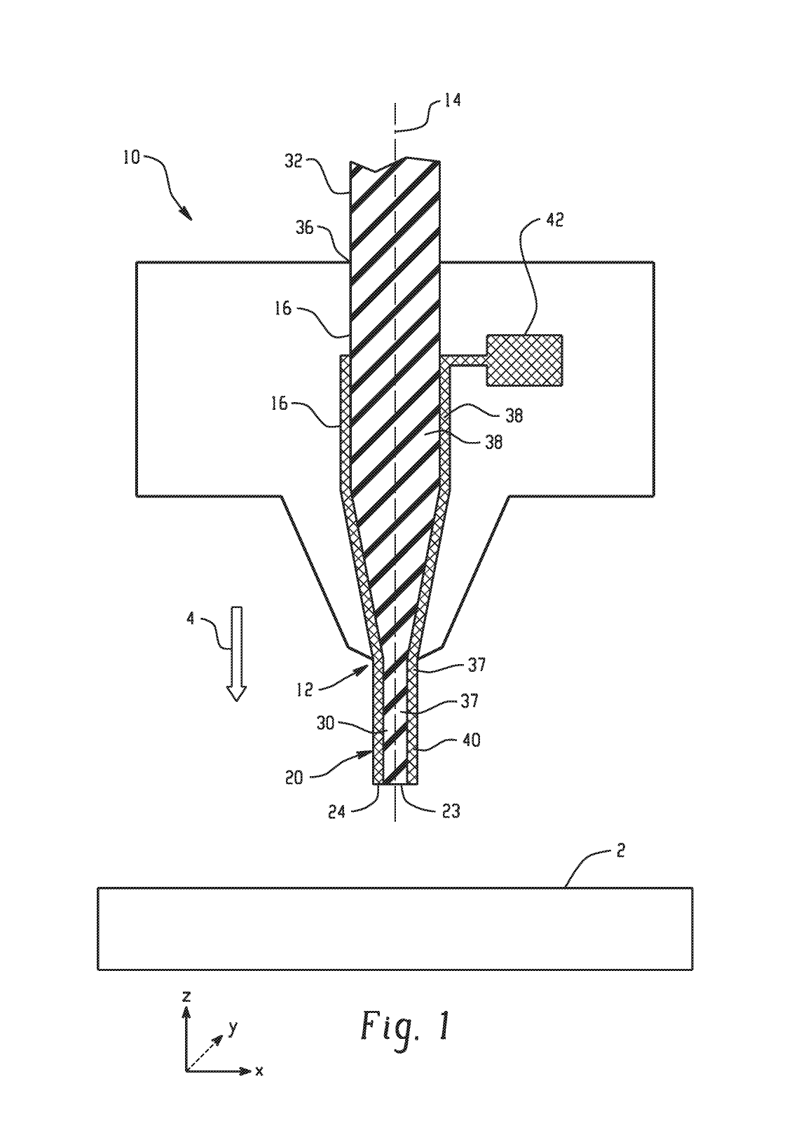

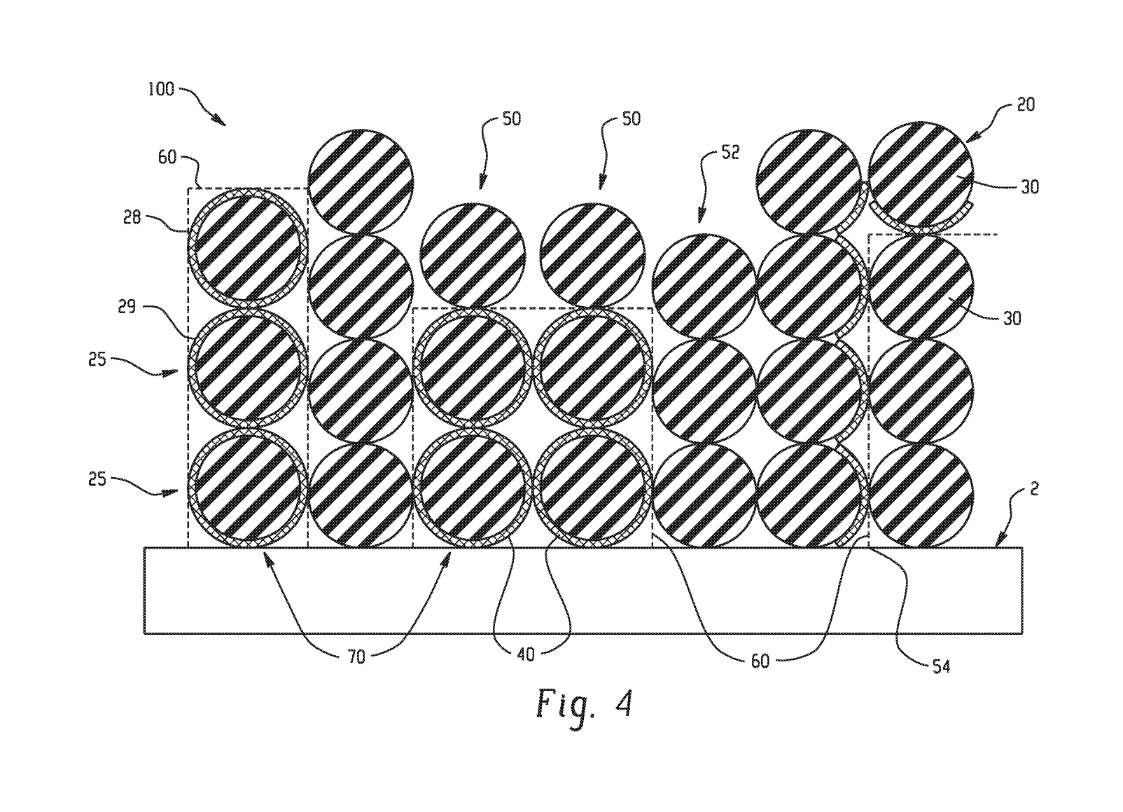

FIG. 1 illustrates an extrusion die 10 which can be used in an additive manufacturing device (e.g., a fused deposition modeling device) to deposit a layer of the multilayered extrudate 20 in a pattern 100 on a platform 2 (see FIG. 4). The extrusion die 10 can have an opening 36 extending through the extrusion die 10. Within the extrusion die 10 the opening 36 can form a feed channel 38 which can correspond to extrudate flow area 37 at an exit 12 of the extrusion die 10. The extrusion die 10 can include two or more feed channels 38 corresponding to two or more extrudate flow areas 37.

The extrusion die 10 can be used to form a multilayered extrudate 20 from a first polymer material 30 and a second material 40. The first polymer material 30 can be in the form of a first filament 32. The first polymer material 30 can be a pellet or a powder and can be introduced to the extrusion die in a flowable form, such as after progressing through a heating section (e.g., screw apparatus as used in an injection molding process). The first polymer material 30 can be heated within the extrusion die 10. Heating within the extrusion die 10 can maintain the first polymer material 30 in a flowable form, can change the phase of the first polymer material 30 from a non-flowable form to a flowable form, such as in the case of a filament 32, or can perform both functions. The first polymer material 30 can be positioned to form a core layer 23 of the multilayered extrudate 20 as it moves through the extrusion die 10. The core layer 23 of first polymer material 30 can be fully or partially surrounded by the second material 40 along at least a portion of an extrusion axis 14 which can be an axis parallel to a movement direction 4 of the multilayered extrudate 20 (e.g., the z-axis in FIGS. 1-3).

The cross-sectional shape of the multilayered extrudate 20 can include any shape, not limited to, but including circular, elliptical, and polygonal (e.g., having straight or curved edges). The cross-sectional shape of the multilayered extrudate 20 can by asymmetric about the extrusion axis 14. The cross-sectional area (e.g., in the x-y plane in FIGS. 1-3) of the first polymer material 30 can be 0.08 millimeter (mm) to 1 mm, for example, 0.1 mm to 0.5 mm, or, 0.02 mm to 0.03 mm, or, 0.25 mm.

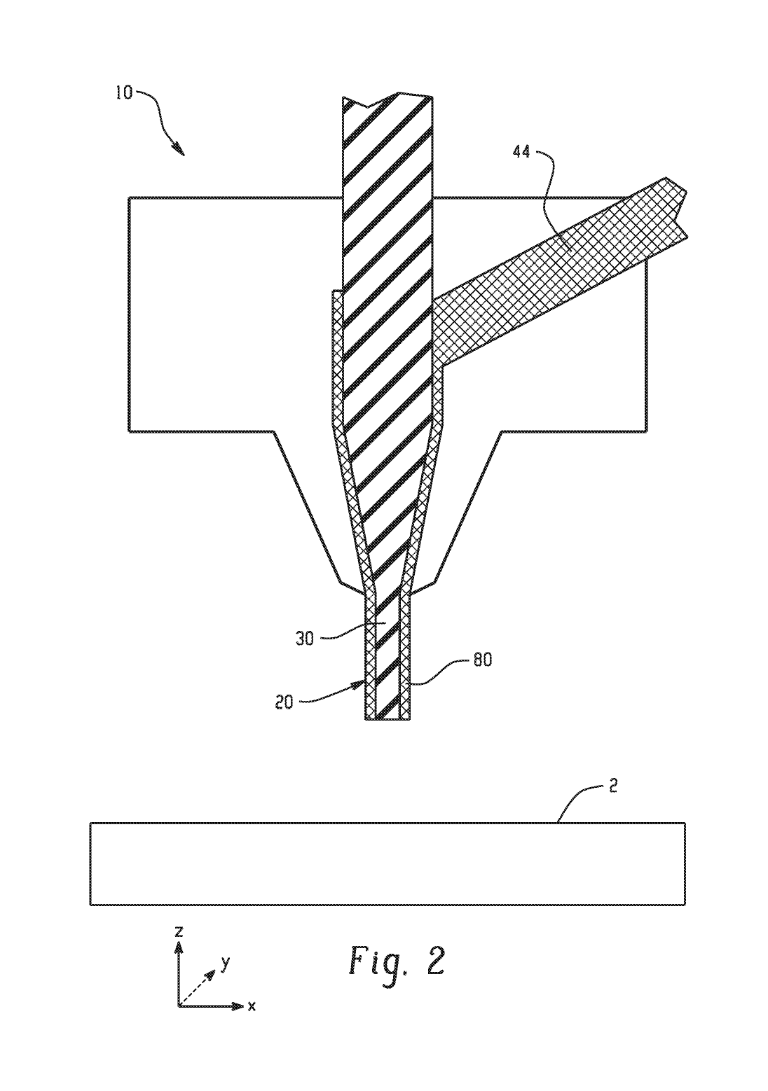

The second material 40 can include a solvent, a release agent, a second polymer material 80 (a material extrusion material as described above) (e.g., see FIG. 2), a functional coating material (e.g., abrasion resistance coating, ultraviolet light protective coating, or the like), or a combination comprising at least one of the foregoing. The second material 40 can be stored in a reservoir 42 of any size (e.g., volume, shape). The second material 40 can be fed through a feed channel 38 (e.g., a second feed channel).

A release agent can be any material that does not stick to the build material and/or prevent the build material from sticking to the support material. Release agents can include a carboxylic acid ester, an ester of a saturated aliphatic long chain monocarboxylic acid (e.g., a ester of C₁₂₋₃₀ aliphatic monocarboxylic acid), a saturated aliphatic carboxylic acid with 10 to 20 carbon atoms per molecule, a univalent aliphatic long chain alcohol, a paraffin wax, an ester wax of montanic acid (e.g., stearyl ester of behenic acid), mono or polyhydroxy aliphatic saturated alcohol (e.g., butyl stearate or stearic acid), an aromatic hydroxy compound with from 1 to 6 hydroxyl groups, a 4-hydric to 6-hydric alcohol, or a combination comprising at least one of the foregoing. It has been found that the addition of saturated and unsaturated normal fatty acids having from fourteen (14) to thirty-six (36) carbon atoms, inclusive, enhance the mold release capability of the other agents. Examples of the saturated acids include myristic, palmitic, stearic, arachidic, behenic and hexatrieisocontanoic (C36) acids. Examples of unsaturated acids include palmitoleic, oleic, linolenic and cetoleic.

The desired solvent will specific to the particular material that is employed. It can include water (e.g., steam), an acetate (e.g., ethyl acetate, ethoxyethyl acetate, methoxyethyl acetate), a ketone (e.g., acetone, methyl ethyl ketone, methyl isobutyl ketone, or aliphatic ketones (e.g., cyclic ketones, such as cyclohexanone)), xylene, white spirit, heavy coal-tar naphtha, kerosene, pinene and turpentine, toluene, or a combination of at least one of the foregoing.

In some embodiments, it may be desirable to additional include coatings to the encompass either the build material or the support material or both. These coatings can include UV- and thermally-cured coatings such as UV- and thermally-cured acrylic and epoxy polymers. In some embodiments, it may be desirable to employ a heated build chamber.

The second material 40 can move through the extrusion die 10 and can form a layer 24 of the multilayered extrudate. The layer 24 can partially or fully surround the core layer 23 (e.g., can form a perimeter layer around the core in a cross section of the multilayered extrudate 20 taken in the x-y plane of FIGS. 1-3). The layer 24 can partially or fully surround the core layer 23 along a portion of the multilayered extrusion 20 extending along the extrusion axis 14. A surrounding layer (e.g. layer 24) can be adjacent to the core layer 23 or can abut the core layer 23.

The cross-sectional shape of the layer 24 can include any shape. The cross-sectional shape of the layer 24 can be the same shape as the core layer 23. The cross-sectional area (e.g., in the x-y plane in FIGS. 1-3) of the layer 24 of the second material can be 0.08 millimeter (mm) to 1 mm, for example, 0.1 mm to 0.5 mm, or, 0.2 mm to 0.3 mm, or, 0.25 mm.

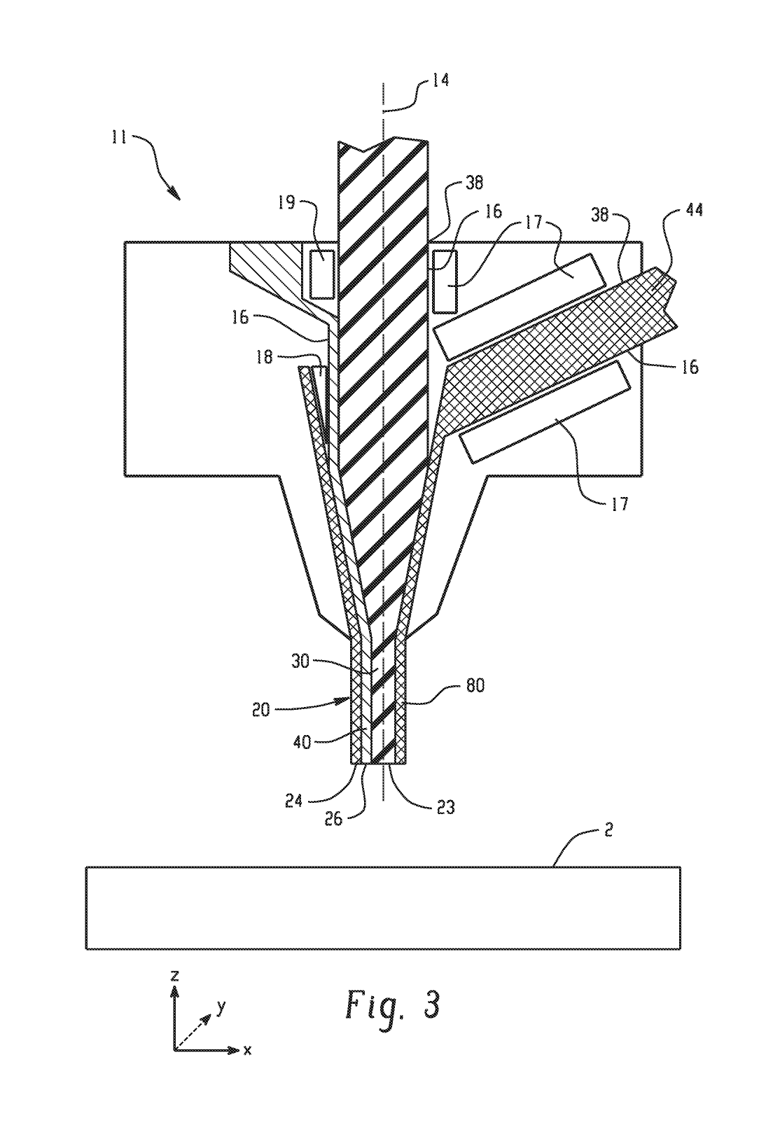

The second material 40 can include a second polymer material 80 in the form of a second filament 44 of (e.g. FIGS. 2-3). The second polymer material 80 can be a pellet or a powder and can be introduced to the extrusion die in a flowable form, such as after progressing through a heating section (e.g., screw apparatus as used in an injection molding process). The second polymer material 80 can be heated within the extrusion die 10. Heating within the extrusion die 10 can maintain the second polymer material 30 in a flowable form, can change the phase of the second polymer material 80 from a non-flowable form to a flowable form, such as in the case of a second filament 44, or can perform both functions. The second polymer material 80 can be a different type of polymer than the first polymer material 30. For example, the second polymer material 80 can be of a different chemical composition, can have different physical properties (e.g., impact strength, glass transition temperature, hardness, flexural modulus, tensile strength, and the like), can have different additives, can have a different color, such as including a different colorants, and the like, in comparison to the first polymer material 30. In an embodiment, the second polymer material 80 can have a higher impact strength than the first polymer material 30 as determined by ASTM D256.

FIG. 3 is an illustration of an extrusion die 11 including a heating device 17 disposed adjacent to a wall 16 of a feed channel 38. The extrusion die 11 can include a cooling device 18 which can be disposed adjacent to a wall 16 of the feed channel 38 through which the extruding material moves. A cooling device 18 (e.g., a coolant channel, thermoelectric device (e.g., a device that demonstrates the Peltier effect), heat pipe, and the like) can be located such that the second material 40 is kept below its vaporization temperature as it passes through the extrusion die 11. The extrusion die 11 can include an insulative portion 19 to reduce heat transfer between the materials that pass through the extrusion die 11.

The second polymer material 80 can move through the extrusion die 11 to form a portion of the multilayered extrudate 20. The second material 40 can move through the extrusion die 11 and can form a layer 26 of the multilayered extrudate 20. The layer 26 can partially or fully surround the core layer 23 (e.g., can form a perimeter layer around the core in a cross section of the multilayered extrudate 20 taken in the x-y plane of FIGS. 1-3). The layer 26 can partially or fully surround the core layer 23 along a portion of the multilayered extrudate 20 extending along the extrusion axis 14. The second polymer material 80 can partially or fully surround the first polymer material 30. The second material 40 can form an intermediate layer 26 between the first polymer material 30 and the second polymer material 80 of the multilayered extrudate 20. A surrounding layer (e.g. layers 24 or 26) can be adjacent to an inner layer (e.g., 23, 26) or can abut an inner layer (e.g., 23, 26). In an embodiment, the second polymer material 80 can form an interlayer between the first polymer material 30 and the second material, such as a solvent, abutting both the first polymer material 30 and the second material 40. In an embodiment, the first polymer material 30 can form a core layer surrounded by and abutting a first solvent, which in turn is surrounded by and abutting a second polymer material 80, which in turn is surrounded by and abutting a second solvent. In an embodiment, the first polymer material 30 can form a core layer surrounded by and abutting a first solvent, which in turn is surrounded by and abutting a second polymer material 80, which in turn is surrounded by and abutting a release agent.

FIG. 4 illustrates a cross section of a pattern 100 of multilayered extrudate 20 deposited on a plat form 2. The movement of the second material 40 can be stopped while extrusion of the first polymer material 30 continues which can form paths 52 free of second material 40. In this way, portions of the pattern 100 can be free of the second material 40. The second material 40 can be extruded in preselected portions of the pattern 100. In other words, the second material can be disposed in some areas of the pattern while other areas of the patter are free of the second material. The second material 40 can form a surface 54 (e.g. outer surface) of the model material 50 which can have a functional coating (e.g., abrasion resistant coating, ultraviolet protective coating, and the like). For example, the second material 40 can form an interface 60 between portions of model material 50 and portions of support material 70. In an embodiment, the first polymer material 30 can be used as the support material 70 and as the model material 50 where the interface 60 between the model material 50 and the support material 70 can be formed by the second material 40.

The cross-sectional area of the second material 40 in the multilayered extrudate 20 can be changed during the extrusion process to provide the desired amount of second material 40 as a function of the position within the three dimensional object. For example, a portion 28 of the multilayered extrudate 20 can have a larger cross-sectional area of the second material (e.g., release agent). A larger cross-sectional area can include a thicker portion or extending around more, surrounding more, of the first polymer material 30. This portion 28 can be deposited in a layer 25 of the pattern 100 that can form an interface 60 between the model material 50 and the support material 70.

Various strategies can be employed to adjust the cross-sectional area of the second material 40 that is extruded into the multilayered extrudate 20 in a path 29 and/or layer 25 of the pattern 100. A strategy can include swapping the extrusion die (10, 11) during the manufacturing process (e.g., in an automated fashion) with another extrusion die (10, 11). A strategy can include changing the cross-sectional area of an opening 36 of the extrusion die (10, 11). Any suitable strategy can be used to extrude a different shape of the second material 40, a different cross-sectional area of the second material 40, a different volumetric flow rate of the second material 40, or a combination comprising at least one of the foregoing, including adjusting the cross-sectional shape of the layer 24 of the second material 40 (e.g., blocking portions of the second material 40 extrudate flow area 37 within the extrusion die (10, 11)).

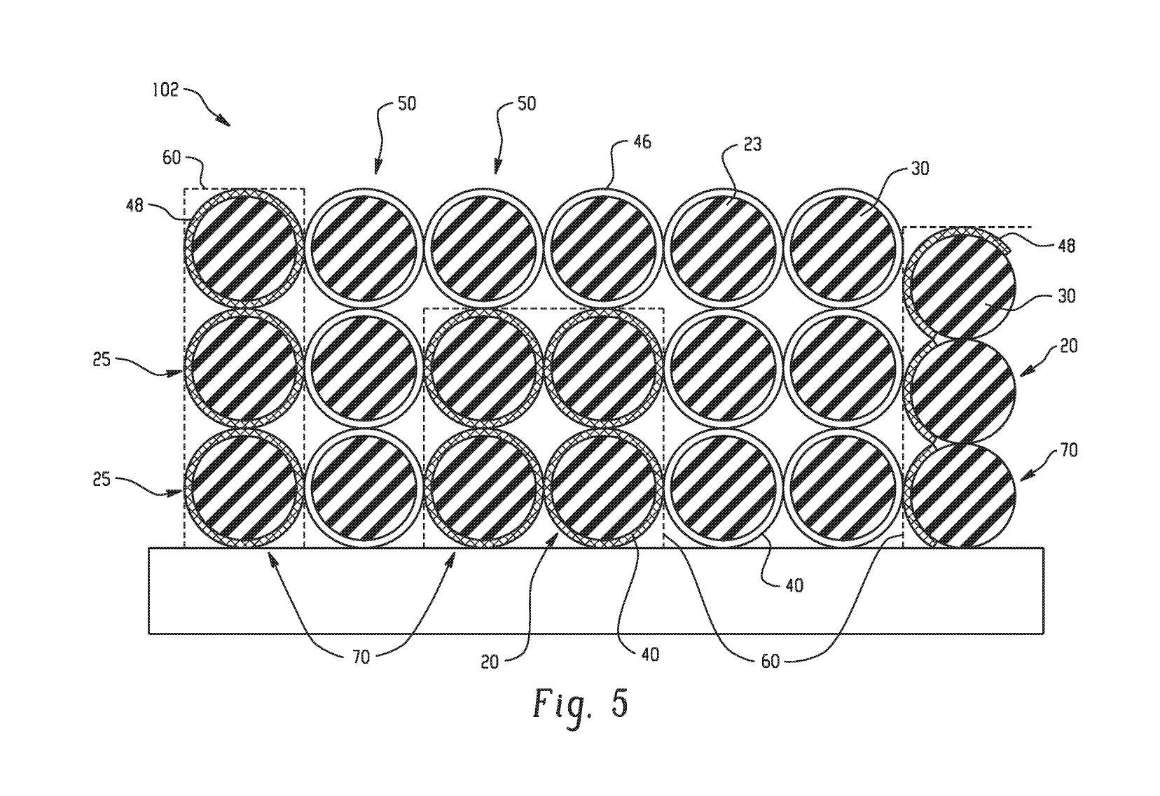

FIG. 5 is an illustration of a pattern 102 including a multilayered extrudate 20 deposited in layers 25. The multilayer extrudate 20 can have a core layer 23 of a first polymer material 30 throughout the pattern 102. The second material 40 of the multilayered extrudate 20 can be changed from a solvent 46 to a release agent 48 in portions of the pattern 102. In this way the adhesion between layers of the model material 50 can be improved by the solvent 46 relative to model material without a solvent layer and the support material 70 can be more easily separated from the model material 50 due to the interface 60 formed by the release agent 48 once the pattern 102 is formed.

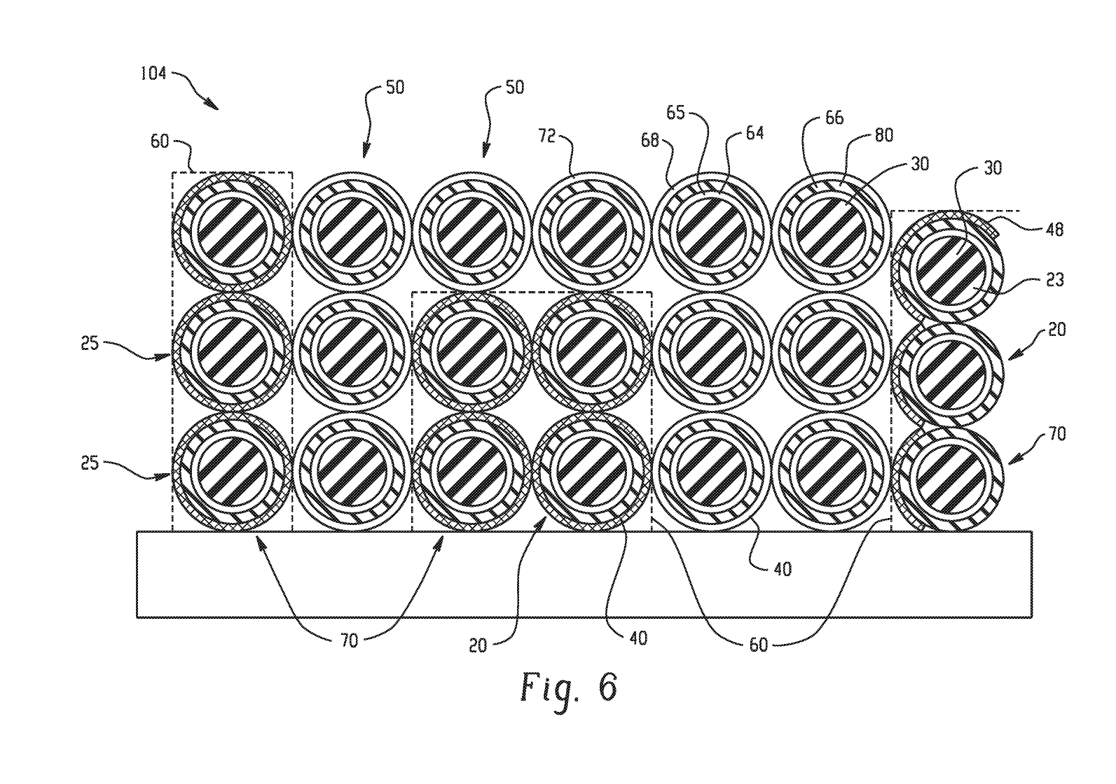

FIG. 6 is an illustration of a pattern 104 including multilayered extrudate 20 deposited in layers 25. The multilayered extrudate 20 can have a core layer 23 of a first polymer material 30 throughout the pattern 102. The multilayered extrudate 20 can have a first interlayer 64 of a first solvent 65 throughout the pattern 102. The multilayered extrudate 20 can have a second interlayer 66 of a second polymer material 80 throughout the pattern 102. The multilayered extrudate 20 can have an outer layer 68 of a second material 40 throughout the pattern 102. The second material 40 can include a release agent 48, a second solvent 72, a function coating, or a combination of at least one of the foregoing. The outer layer 68 of the multilayered extrudate 20 can be changed from a second solvent 72 to a release agent 48 in portions of the pattern 102. In this way the adhesion between layers (25, 64, 66, 68) of the model material 50 can be improved by the solvents (65, 72) relative to other methods of manufacturing including model material 50 without solvents (65, 72). The support material 70 can be more easily separated from the model material 50 due to the interfaces 60 formed by the release agent 48 once the pattern 102 is formed.

Once formed the support material 70 can be separated from the model material 50 of the pattern (100, 102, 104). The use of a release agent along model/support interfaces can allow for easier removal of the support in comparison to other additive manufacturing methods. Additional post process steps such as sanding, curing, and/or additional finishing can be performed on the part. In an embodiment, utilizing a release agent along boundary surfaces within the article can reduce the need for post process steps since the model can be more separated from the support material more easily. Accordingly, an increase in production rate and product quality can be attained in using the system and methods described herein.

The following embodiments illustrate the present invention:

### Embodiment 1

A method of forming a three dimensional object comprising: moving a first polymer material through a first feed channel of an extrusion die having multiple feed channels; moving a second material through a second feed channel of the extrusion die, wherein the second material comprises at least one of a solvent, a release agent, a coating, and a second polymer material; forming a multilayered extrudate along an extrusion axis, wherein the multilayered extrudate comprises the first polymer material and the second material, and wherein the extrusion axis is parallel to the movement of the multilayered extrudate; depositing a multitude of layers of the multilayered extrudate in a preset pattern on a platform; and fusing the multitude of layers to form the three dimensional object.

### Embodiment 2

The method of Embodiment 1, wherein the second material comprises only one of the solvent, the release agent, the coating, and the second polymer material

### Embodiment 3

The method of any of Embodiments 1-2, further comprising surrounding the first polymer material with the second material along a portion of the extrusion axis.

### Embodiment 4

The method of any of Embodiments 1-3, further comprising stopping movement of the second material at a predetermined position of the pattern.

### Embodiment 5

The method of any of Embodiments 1-4, further comprising heating the first polymer material to a temperature greater than or equal to the glass transition temperature or the melting point temperature of the first polymer material as it passes through the extrusion die.

### Embodiment 6

The method of any of Embodiments 1-5, wherein the second material comprises the solvent; and further comprising moving a second polymer material through a third feed channel of the extrusion die; wherein the multilayered extrudate further comprises the second polymer material and the solvent surrounds the first polymer material and is disposed as an intermediate layer between the first polymer material and the second polymer material.

### Embodiment 7

The method of Embodiments 6, further comprising heating the second polymer material to a temperature greater than or equal to the glass transition temperature or the melting point temperature of the second polymer material as it passes through the extrusion die.

### Embodiment 8

The method of any of Embodiments 1-5, wherein the second material comprises at least one of the solvent and the release agent (preferably wherein the second material comprises the solvent or the release agent); and further comprising cooling the second material to a temperature less than or equal to the vaporization temperature of the second material as it passes through the extrusion die.

### Embodiment 9

The method of any of Embodiments 8, wherein the second material comprises the solvent or the release agent; and further comprising washing the solvent or the release agent from the three dimensional object.

### Embodiment 10

The method of any of Embodiments 1-9, wherein the first polymer material comprises a first filament, a first powder, a first pellet, or a combination of at least one of the foregoing.

### Embodiment 11

The method of any of Embodiments 6-7, wherein the second material comprises the second polymer material and comprises a second filament, a second powder, a second pellet, or a combination of at least one of the foregoing.

### Embodiment 12

The method of any of Embodiments 6-7 or 11, wherein the impact strength of the second polymer material is less than or equal to the impact strength of the first polymer material.

### Embodiment 13

The method of any of Embodiments 1-12, further comprising adjusting a flow rate of the second material, a cross-sectional shape of the second material, a cross-sectional area of the second material, or a combination of at least one of the foregoing along a path of the pattern.

### Embodiment 14

A method of forming a three dimensional object comprising: moving a first polymer material through a first feed channel of an extrusion die having multiple feed channels; moving a first solvent through a second feed channel of the extrusion die; forming a multilayered extrudate along an extrusion axis, wherein the multilayered extrudate comprises the first polymer material and the first solvent, and wherein the extrusion axis is parallel to the movement of the multilayered extrudate; depositing a multitude of layers of the multilayered extrudate in a preset pattern on a platform; and fusing the multitude of layers to form the three dimensional object.

### Embodiment 15

The method of Embodiment 14, wherein the first solvent improves adhesion between the multitude of layers along all three dimensions of the three dimensional object.

### Embodiment 16

The method of any of Embodiments 14-15, further comprising surrounding the first polymer material with the first solvent along a portion of the extrusion axis.

### Embodiment 17

The method of any of Embodiments 14-16, further comprising moving a second polymer material through a third feed channel of the extrusion die; wherein the multilayered extrudate further comprises the second polymer material.

### Embodiment 18

The method of Embodiment 17, further comprising surrounding the first polymer material with the second polymer material along a portion of the extrusion axis, and wherein the first solvent forms an intermediate layer between and abutting both the first polymer material and the second polymer material.

### Embodiment 19

The method of any of Embodiments 17-18, further comprising moving a second solvent through a fourth feed channel of the extrusion die, and wherein the multilayered extrudate further comprises the second solvent.

### Embodiment 20

The method of Embodiment 19, further comprising surrounding the second polymer material with the second solvent along a portion of the extrusion axis.

### Embodiment 21

The method of Embodiment 17, further comprising surrounding the first polymer material with the second polymer material along a portion of the extrusion axis, wherein the first solvent surrounds both the first polymer material and the second polymer material and forms an outer layer abutting the second polymer material.

### Embodiment 22

The method of any of Embodiments 19-20, wherein the second solvent improves adhesion between the layers along all three dimensions of the three dimensional object.

### Embodiment 23

The method of any of Embodiments 17-22, wherein the impact strength of the second polymer material is less than or equal to the impact strength of the first polymer material.

### Embodiment 24

The method of any of Embodiments 14-23, further comprising adjusting a flow rate of the first solvent, a cross-sectional shape of the first solvent, a cross-sectional area of the first solvent, or a combination of at least one of the foregoing along a path of the pattern.

### Embodiment 25

The method of any of Embodiments 14-24, further comprising stopping the movement of the first solvent at a predetermined position of the pattern.

### Embodiment 26

The method of Embodiment 25, further comprising moving a release agent through the second feed channel of the extrusion die, wherein the multilayered extrudate comprises the first polymer material and the release agent.

### Embodiment 27

The method of any of Embodiments 1-26, further comprising forming a support of the three dimensional object from the multilayered extrudate.

### Embodiment 28

A method of forming a three dimensional object comprising: moving a first polymer material through a first feed channel of an extrusion die having multiple feed channels; moving a release agent through a second feed channel of the extrusion die; forming a multilayered extrudate along an extrusion axis, wherein the multilayered extrudate comprises the first polymer material and the release agent, and wherein the extrusion axis is parallel to the movement of the multilayered extrudate; depositing a multitude of layers of the multilayered extrudate in a preset pattern on a platform; and fusing the multitude of layers to form the three dimensional object.

### Embodiment 29

The method of Embodiment 28, further comprising adjusting a flow rate of the release agent, a cross-sectional shape of the release agent, a cross-sectional area of the release agent, or a combination of at least one of the foregoing along a path of the pattern.

### Embodiment 30

The method of any of Embodiments 28-29, further comprising stopping movement of the release agent at a predetermined position of the pattern.

### Embodiment 31

The method of any of Embodiments 28-30, further comprising moving a second polymer material through a third feed channel of the extrusion die, and wherein the multilayered extrudate further comprises the second polymer material.

### Embodiment 32

The method of Embodiment 31, further comprising surrounding both the first polymer material and the second polymer material with the release agent along a portion of the extrusion axis, wherein the release agent forms an outer layer abutting the second polymer material

### Embodiment 33

The method of any of Embodiments 28-32, further comprising forming a support of the three dimensional object from the multilayered extrudate.

### Embodiment 34

The method of any of Embodiments 28-33, further comprising washing the release agent from the three dimensional object.

### Embodiment 35

A method of forming a three dimensional object comprising: moving a first polymer material through a first feed channel of an extrusion die having multiple feed channels; moving a second material through a second feed channel of the extrusion die, wherein the second material comprises at least one of a first solvent, a release agent, and a coating, or a second polymer material; forming a multilayered extrudate along an extrusion axis, wherein the multilayered extrudate comprises the first polymer material and the second material, and wherein the extrusion axis is parallel to the movement of the multilayered extrudate; depositing a multitude of layers of the multilayered extrudate in a preset pattern on a platform; and fusing the multitude of layers to form the three dimensional object.

### Embodiment 36

The method of Embodiment 35, further comprising surrounding the first polymer material with the second material along a portion of the extrusion axis.

### Embodiment 37

The method of any of Embodiments 35-36, further comprising stopping movement of the second material at a predetermined position of the pattern.

### Embodiment 38

The method of any of Embodiments 35-37, wherein the second material comprises at least one of the first solvent and the release agent; and further comprising cooling the second material to a temperature less than or equal to the vaporization temperature of the second material as it passes through the extrusion die.

### Embodiment 39

The method of any of Embodiments 35-38, wherein the second material comprises the first solvent.

### Embodiment 40

The method of any of Embodiments 35-39, further comprising moving a second polymer material through a third feed channel of the extrusion die, and wherein the multilayered extrudate further comprises the second polymer material.

### Embodiment 41

The method of Embodiment 40, wherein the first solvent surrounds the first polymer material and is disposed as an intermediate layer between the first polymer material and the second polymer material.

### Embodiment 42

The method of any of Embodiments 35-39, wherein the second material comprises the second polymer material.

### Embodiment 43

The method of Embodiment 42, further comprising moving the second polymer material through a third feed channel of the extrusion die; wherein the multilayered extrudate further comprises the second polymer material; and surrounding the first polymer material with the second polymer material along a portion of the extrusion axis, and wherein the first solvent forms an intermediate layer between and abutting both the first polymer material and the second polymer material.

### Embodiment 44

The method of any of Embodiments 35-43, wherein the second material comprises the second polymer material and comprises a second filament, a second powder, a second pellet, or a combination of at least one of the foregoing.

### Embodiment 45

The method of any of Embodiments 35-44, wherein the impact strength of the second polymer material is less than or equal to the impact strength of the first polymer material.

### Embodiment 46

The method of any of Embodiments 35-45, wherein the first solvent improves adhesion between the multitude of layers along all three dimensions of the three dimensional object.

### Embodiment 47

The method of any of Embodiments 35-46, further comprising surrounding the first polymer material with the first solvent along a portion of the extrusion axis.

### Embodiment 48

The method of any of Embodiments 35-47, wherein the impact strength of the second polymer material is less than or equal to the impact strength of the first polymer material.

### Embodiment 49

The method of any of Embodiments 35-48, wherein the second material comprises the release agent.

### Embodiment 50

The method of any of Embodiments 35-49, further comprising stopping the movement of the first solvent at a predetermined position of the pattern, moving the release agent through the second feed channel of the extrusion die, wherein the multilayered extrudate comprises the first polymer material and the release agent.

### Embodiment 51

The method of any of Embodiments 35-50, further comprising adjusting a flow rate of the second material, a cross-sectional shape of the second material, a cross-sectional area of the second material, or a combination of at least one of the foregoing along a path of the pattern.

### Embodiment 52

The method of any of Embodiments 35-51, further comprising surrounding both the first polymer material and the second polymer material with the release agent along a portion of the extrusion axis, wherein the release agent forms an outer layer abutting the second polymer material.

### Embodiment 53

The method of any of Embodiments 35-52, further comprising forming a support of the three dimensional object from the multilayered extrudate.

### Embodiment 54

An article of manufacture comprising the three dimensional object of any of Embodiments 35-53.

### Embodiment 55

An article of manufacture comprising: a three dimensional object comprising a part made from a first polymer material and a support made from the first polymer material wherein the part and the support are separated by a release agent.

### Embodiment 56

The article of manufacturing of Embodiment 55, wherein the part further comprises a second polymer material.

### Embodiment 57

The article of manufacturing of any of Embodiments 35-56, wherein the impact strength of the second polymer material is less than or equal to the impact strength of the first polymer material.

### Embodiment 58

The article of manufacturing of any of Embodiment 35-55, wherein the first polymer material further comprises a uniquely encoded chemical identifier, a uniquely encoded microscopic material, or both a uniquely encoded chemical identifier and a uniquely encoded microscopic material.

### Embodiment 59

The article of manufacturing of any of Embodiments 35-58, wherein one of the first polymer material and the second polymer material further comprises a uniquely encoded chemical identifier, a uniquely encoded microscopic material, or both a uniquely encoded chemical identifier and a uniquely encoded microscopic material.

### Embodiment 60

The article of manufacturing of any of Embodiments 35-59, wherein one of the first polymer material and the second polymer material comprises polycarbonate, acrylonitrile butadiene styrene, acrylic rubber, liquid crystal polymer, methacrylate styrene butadiene, polyacrylates (acrylic), polyacrylonitrile, polyamide, polyamide-imide, polyaryletherketone, polybutadiene, polybutylene, polybutylene terephthalate, polycaprolactone, polyethylene terephthalate, polycyclohexylene dimethylene terephthalate, polyhydroxyalkanoates, polyketone, polyesters, polyester carbonates, polyethylene, polyetheretherketone, polyetherketoneketone, polyetherimide, polyethersulfone, polysulfone, polyimide, polylactic acid, polymethylpentene, polyolefins, polyphenylene oxide, polyphenylene sulfide, polyphthalamide, polypropylene, polystyrene, polysulfone, polyphenylsulfone, polytrimethylene terephthalate, polyurethane, styrene-acrylonitrile, polycarbonate copolymers, silicone polycarbonate copolymers, or a combination comprising at least one of the foregoing.

### Embodiment 61

The article of manufacturing of any of Embodiments 35-60, wherein the release agent comprises a carboxylic acid ester, an ester of a saturated aliphatic long chain monocarboxylic acid, a saturated aliphatic carboxylic acid with 10 to 20 carbon atoms per molecule, a univalent aliphatic long chain alcohol, a paraffin wax, an ester wax of montanic acid, mono or polyhydroxy aliphatic saturated alcohol, an aromatic hydroxy compound with from 1 to 6 hydroxyl groups, a 4-hydric to 6-hydric alcohol, or a combination comprising at least one of the foregoing.

### Embodiment 62

The article of manufacturing of any of Embodiments 35-61, wherein the solvent comprises water, an acetate, a ketone, xylene, white spirit, heavy coal-tar naphtha, kerosene, pinene and turpentine, toluene, or a combination of at least one of the foregoing.

### Embodiment 63

The article of manufacturing of any of Embodiments 35-62, wherein the article comprises areas free of the second material.

### Embodiment 64

The article of manufacturing of any of Embodiments 35-63, wherein the second material forms a pattern in the article.

### Embodiment 65

The article of manufacturing of any of Embodiments 35-64, wherein the second material is not located randomly in the article.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention.

All ranges disclosed herein are inclusive of the endpoints, and the endpoints are independently combinable with each other (e.g., ranges of “up to 25 wt. %, or more specifically, 5 wt. % to 20 wt. %”, is inclusive of the endpoints and all intermediate values of the ranges of “5 wt. % to 25 wt. %” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A method of forming a three dimensional object comprising:
moving a first polymer material through a first feed channel of an extrusion die having multiple feed channels;
moving a second material through a second feed channel of the extrusion die, wherein the second material comprises at least one of a first solvent, a release agent, and a coating, or a second polymer material;
forming a multilayered extrudate along an extrusion axis, wherein the multilayered extrudate comprises the first polymer material and the second material, and wherein the extrusion axis is parallel to the movement of the multilayered extrudate;
depositing a multitude of layers of the multilayered extrudate in a preset pattern on a platform; and
fusing the multitude of layers to form the three dimensional object;
further, at least one of
stopping movement of the second material at a predetermined position of the pattern;
wherein the second material comprises the second polymer material;
wherein the second material comprises at least one of the first solvent and the release agent; and further comprising cooling the second material to a temperature less than or equal to the vaporization temperature of the second material as it passes through the extrusion die;
wherein the second material comprises the first solvent;
wherein the impact strength of the second polymer material is less than or equal to the impact strength of the first polymer material;
wherein the first solvent improves adhesion between the multitude of layers along all three dimensions of the three dimensional object; and
wherein the second material comprises the release agent.

2. The method of claim 1, further comprising surrounding the first polymer material with the second material along a portion of the extrusion axis.

3. The method of claim 1, wherein the second material can form an interface between at least a portion of a model material and at least a portion of a support material, wherein the model material includes the first polymer material.

4. The method of claim 1, wherein the second material comprises at least one of the first solvent and the release agent; and further comprising cooling the second material to a temperature less than or equal to the vaporization temperature of the second material as it passes through the extrusion die.

5. The method of claim 1, wherein the second material comprises the first solvent.

6. The method of claim 1, further comprising moving a second polymer material through a third feed channel of the extrusion die, and wherein the multilayered extrudate further comprises the second polymer material.

7. The method of claim 6, wherein the first solvent surrounds the first polymer material and is disposed as an intermediate layer between the first polymer material and the second polymer material.

8. The method of claim 1, wherein the second material comprises the second polymer material.

9. The method of claim 8, further comprising moving the second polymer material through a third feed channel of the extrusion die; wherein the multilayered extrudate further comprises the second polymer material; and surrounding the first polymer material with the second polymer material along a portion of the extrusion axis, and wherein the first solvent forms an intermediate layer between and abutting both the first polymer material and the second polymer material.

10. The method of claim 1, wherein the second material comprises the second polymer material and comprises a second filament, a second powder, a second pellet, or a combination of at least one of the foregoing.

11. The method of claim 1, wherein the impact strength of the second polymer material is less than or equal to the impact strength of the first polymer material.

12. The method of claim 1, wherein the first solvent improves adhesion between the multitude of layers along all three dimensions of the three dimensional object.

13. The method of claim 1, further comprising surrounding the first polymer material with the first solvent along a portion of the extrusion axis.

14. (canceled)

15. The method of claim 1, wherein the second material comprises the release agent.

16. The method of claim 1, further comprising stopping the movement of the first solvent at a predetermined position of the pattern, moving the release agent through the second feed channel of the extrusion die, wherein the multilayered extrudate comprises the first polymer material and the release agent.

17. he method of claim 1, further comprising adjusting a flow rate of the second material, a cross-sectional shape of the second material, a cross-sectional area of the second material, or a combination of at least one of the foregoing along a path of the pattern.

18. The method of claim 1, further comprising surrounding both the first polymer material and the second polymer material with the release agent along a portion of the extrusion axis, wherein the release agent forms an outer layer abutting the second polymer material.

19. The method of claim 1, further comprising forming a support of the three dimensional object from the multilayered extrudate.

20. An article of manufacture comprising the three dimensional object made by the method of claim 1.

21. The method of claim 3, further comprising separating the support material (70) from the model material.
